(19) United States
(12) Patent Application Publication
(10) Pub. No.: US 2014/0032718 A1
(43) Pub. Date: Jan. 30, 2014

(54) VIDEO UPLOADING FROM MOBILE DEVICES

(71) Applicant: Penthera Partners, Inc., Pittsburgh, PA (US)

(72) Inventors: Adam L. Berger, Pittsburgh, PA (US); Gary N. Wallace, JR., Butler, PA (US); Joshua Pressnell, Dayton, OH (US)

(21) Appl. No.: 13/900,221

(22) Filed: May 22, 2013

Related U.S. Application Data
(60) Provisional application No. 61/675,128, filed on Jul. 24, 2012.

(51) Int. Cl. H04L 29/08

(52) U.S. Cl. CPC H04L 67/06
USPC 709/219

(57) ABSTRACT

Among other things, two or more versions of at least portions of a video that has been captured at a mobile device are uploaded from the mobile device to a remote server. Each of the two or more versions requires a different amount of communication resources. The order of uploading of the respective versions is determined based on a size of the version.

### CROSS-REFERENCE

This application claims priority to U.S. Provisional Application Ser. No. 61/675,128, filed Jul. 24, 2012, the contents of which are incorporated here by reference.

### BACKGROUND

This description relates to video uploading from mobile devices such as smartphones and tablets and a wide variety of other mobile devices.

Modern smartphones and tablets have high-resolution video cameras capable of shooting videos in high-definition (e.g., 1080 p) format. The resulting videos, which are stored on the local persistent memory of the device, can be large—often over 100 MB per minute of video.

People often want to perform the following actions with a video they produced on a mobile device: (1) share the video with friends and family; (2) archive the video using a reliable, remote Internet-connected storage service.

Both actions require transferring the video from the mobile device to a remote Internet-connected server. The remote server will store the videos and serve them to, among other things, Internet-connected devices, including smartphones, tablets, laptops, and IP-enabled TVs.

Video transfer from a smartphone or tablet to a remote server can be a complicated process. Most email applications forbid users from attaching a large file to an email: a common limit is 20MB, which equates to only a few seconds of high-quality video. Even if you could find a software tool for transmitting the video, uploading the video from a mobile device through a typical cellular data connection can take hours.

Some software products compress videos to an extremely low quality format (e.g., reduce the resolution from 1080 pixels wide to 360 pixels wide, and reduce the frame rate from 30 to 15 frames per second). Of course, this results in a much lower-quality video, which is a compromise that many users do not wish to make; typically, users wish to preserve (completely, or as much as possible) the original quality of their video.

Typically, an important criterion for sharing is to do it quickly. For example, someone might be at a child's musical performance and wish to share a video with friends or relatives, within minutes of the performance. By contrast, an important criterion for archiving is preserving the quality of the original video.

### SUMMARY

Reconciling these two criteria, sharing the video quickly and preserving the original quality of the video, is a key focus of the concepts that we describe here.

In general, in an aspect, two or more versions of at least portions of a video that has been captured at a mobile device are uploaded from the mobile device to a server. Each of the two or more versions requires a different amount of communication resources.

Implementations may include one or more of the following features. The order of the uploading of the respective versions is determined based on a size of the version. The two or more versions include two or more degrees of compression. One of the versions has not been compressed and at least one of the versions has been compressed. The order of uploading corresponds to relative degrees of compression of the two or more versions. One or more of the two or more versions are to be stored at the server for delivery to other devices. The uploading includes uploading a highly-compressed, low-quality version of the video first, and subsequently uploading one or more higher-quality larger versions of the video. The uploading includes uploading a higher-quality version of the video to replace a lower-quality version. The uploading includes uploading a higher-quality version of the video to be maintained in addition to a lower-quality version. The versions of the video are uploaded from a mobile application running on the mobile device. Information about videos that have been captured on the device is displayed to a user of the mobile device. A user may configure the uploading. A user of the mobile device can select one or more recipients with whom to share the video. Uploading is controlled based on uploading conditions. Uploading is deferred for files larger than a predetermined size until a local wireless connection having a relatively large bandwidth is available. Uploading is deferred for files larger than a predetermined size until a charge level of a battery of the device exceeds a predetermined threshold. Uploading is deferred for files larger than a predetermined size until a charge level of the battery of the device exceeds a predetermined threshold and a Wi-Fi connection is available. A user of the device is notified that the uploading is pending. A number of videos remaining to be uploaded or a number of bytes of files to be uploaded or both is indicated to a user of the mobile device. A progress of uploading of each of two or more different versions of a single video is indicated to a user of the mobile device. A user of the mobile device is enabled to control an order in which the two or more versions are uploaded or to delete a pending upload or both. The uploading includes interleaving the uploading of two or more versions of each of two or more videos so that lower-quality versions of two or more of the videos are uploaded before higher-quality versions of any of the videos are uploaded. A user of the mobile device is enabled to control how or when or both the videos are uploaded. A user is enabled to set a battery threshold below which uploading a video should be suspended. The state of conditions that relate to the favorability of uploading is displayed to the user. The conditions are monitored. The conditions include one or more of a power state or availability of a cellular connection to upload additional data within a subscription.

In general, in an aspect, at a server at a location that is accessible from mobile devices through a public network, two or more successively uploaded versions of at least portions of videos that have been captured at the mobile devices are received. At least one of the later uploaded versions is of a higher-quality than one of the previously uploaded versions for a given one of the videos.

Implementations may include one or more of the following features. One or more of the versions of a given video are delivered to one or more devices other than the one at which the video was captured. The delivering to the one or more other devices occurs almost immediately after the video has been captured. Lower quality versions of a given video are deleted from the server after higher-quality versions have been uploaded to the server. The delivering includes streaming. The delivering includes downloading of the file, stored on the recipient device for later playback.

In general, in an aspect, at a server that is accessible from mobile devices and other devices, managing (a) two or more versions of respective videos that are captured on mobile devices are uploaded, (b) two or more of the versions are stored, and (c) one or more of the versions of a given video are delivered to one or more of the mobile devices or other devices or other devices.

Implementations include one or more of the following features. Ownership of videos among users of the devices is tracked. Identities of users who are authorized to view the respective videos are tracked. Notifications are sent to users who are potential recipients of videos to indicate that the videos have been shared by the owners with those potential recipients. The managing includes causing the deletion of one or more versions of a given one of the stored videos. The managing includes posting a given video on a social network site. The managing includes sending an e-mail or text message containing a link to a given one of the videos to an authorized recipient of the video. The managing includes responding to a request from one of the devices for access to one of the videos by arranging for the device to have access from the storage. The managing includes delivering a lower quality version of a given video until a higher-quality version is available in storage.

In general, in an aspect, a mobile device includes an application to upload two or more versions of at least portions of a video that has been captured at the mobile device through a public communication network to a server for storage, the respective versions being uploaded in order determined based on a size of the version and an urgency of uploading.

Implementations may include one or more of the following features. The mobile device includes a video capture device. The application is to form one or more of the versions by compressing a version of the video. The application is to enable a user to control the uploading. The application is to indicate to the user a status of the uploading. The monitoring element is to monitor conditions of the mobile device associated with it capability to upload. The conditions include a power state and a usage level of bandwidth of a communication subscription.

These and other aspects, features, implementations, and advantages can be expressed as methods, business methods, apparatus, systems, components, means or steps for performing functions, program products, and in other ways.

These and other aspects, features, and implementations, and advantages will become apparent from the following description, and from the claims.

### DESCRIPTION

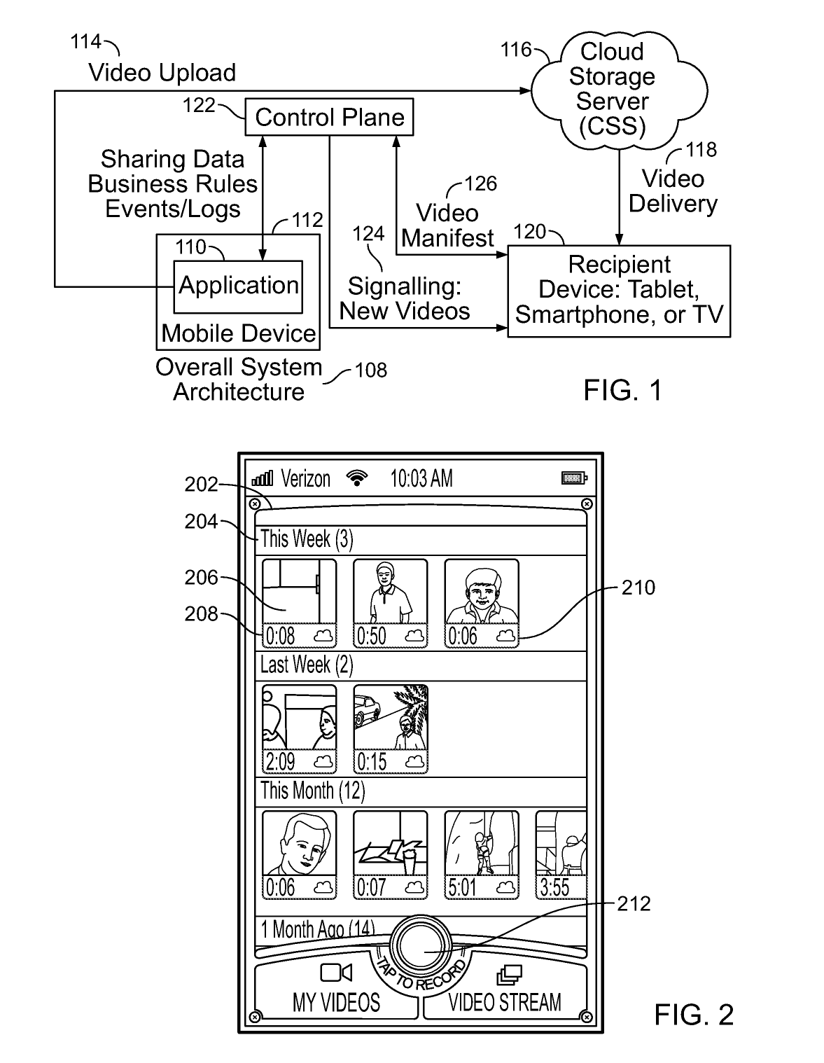

FIG. 1 is a block diagram.

FIGS. 2 through 4, and 6 through 10 are screen shots.

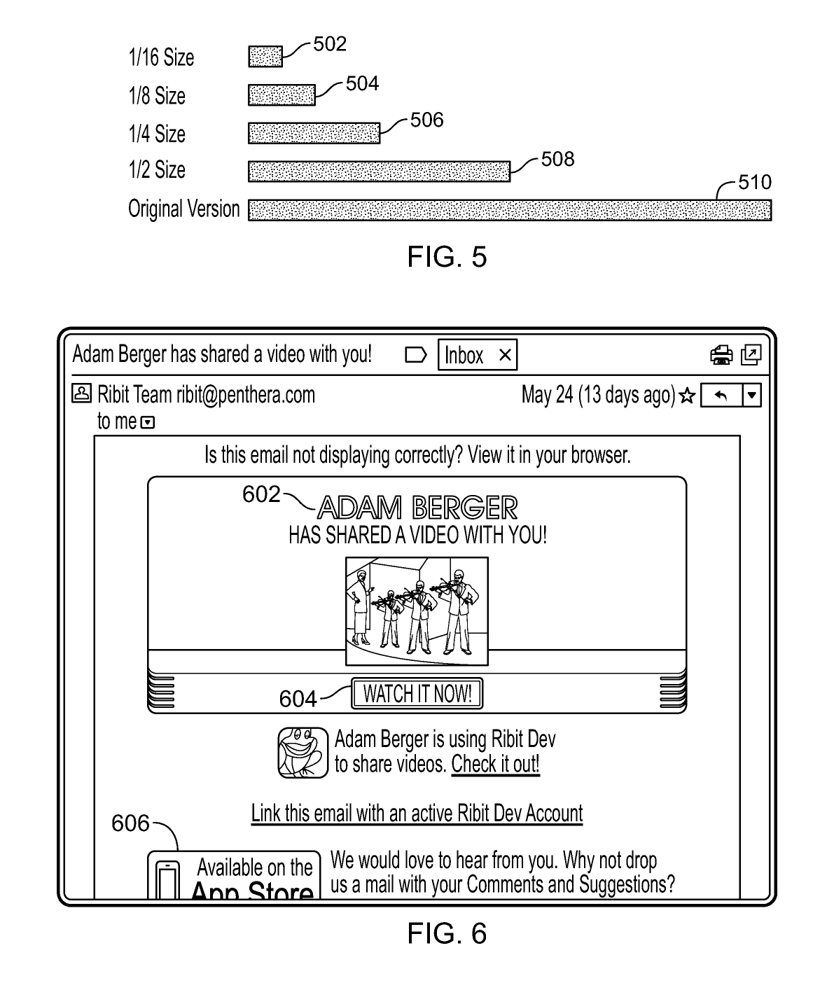

FIG. 5 is a schematic diagram.

Here we describe a way to enable rapid sharing of a video and also allow the archiving of a high-fidelity version of that video.

Suppose a large video file resides on a mobile device and the device owner wishes to upload the video to a remote storage system in order to archive and share it.

A key insight in what we describe here is to first upload from the mobile device a highly-compressed, low-quality version of the video, to allow for quick sharing. Subsequently, we upload one or more higher-quality, larger versions of that same video. Once uploaded, the one or more higher-quality versions will replace, or be maintained in addition to, the lower-quality one.

As shown in FIG. 1, some implementations of our idea include the following components:
(1) an Application 110 on a Mobile Device 112, which handles the upload 114 of the video
(2) a cloud storage system (CSS) 116, which receives the uploaded videos, stores them, and delivers them (as a file or a stream 118) to a Recipient Device 120;
(3) a “Control Plane” system 122, which manages who owns which video, who is authorized to view each video, and transmitting notifications/alerts 124 and video details 126 to recipients 120 when the owner 112 of a video shares it with the recipient 120, who may be accessing the video from a smartphone, tablet, or a TV. The Control Plane may be implemented using standard software tools: web server, database, business logic components. The Control Plane may be hosted at an Internet Service Provider. The Control Plane provides access to a systems administrator who can log in with a password and access diagnostic information about the status and overall usage of the Control Plane. The Control Plane maintains a database of all files uploaded to and stored on the CSS, and also maintains a database of all users of the system, and all videos that have been shared, along with the recipients.

We now present one example of how such a system can behave.

A user shoots a video using her mobile device 112.

Then, the user launches the mobile app. As shown in FIG. 2, the app presents a display of videos 206 belonging to the user. In this particular example, the videos are organized chronologically 204, but they may also be presented in other ways, e.g. highlighting as-yet unviewed videos, or videos marked as favorites, etc.

Some of the videos shown in this display may reside on the device itself. Others may reside on a remote server. The application may visually distinguish those that reside on the remote server with an icon 210. The user may also create a new video 212 from within the app.

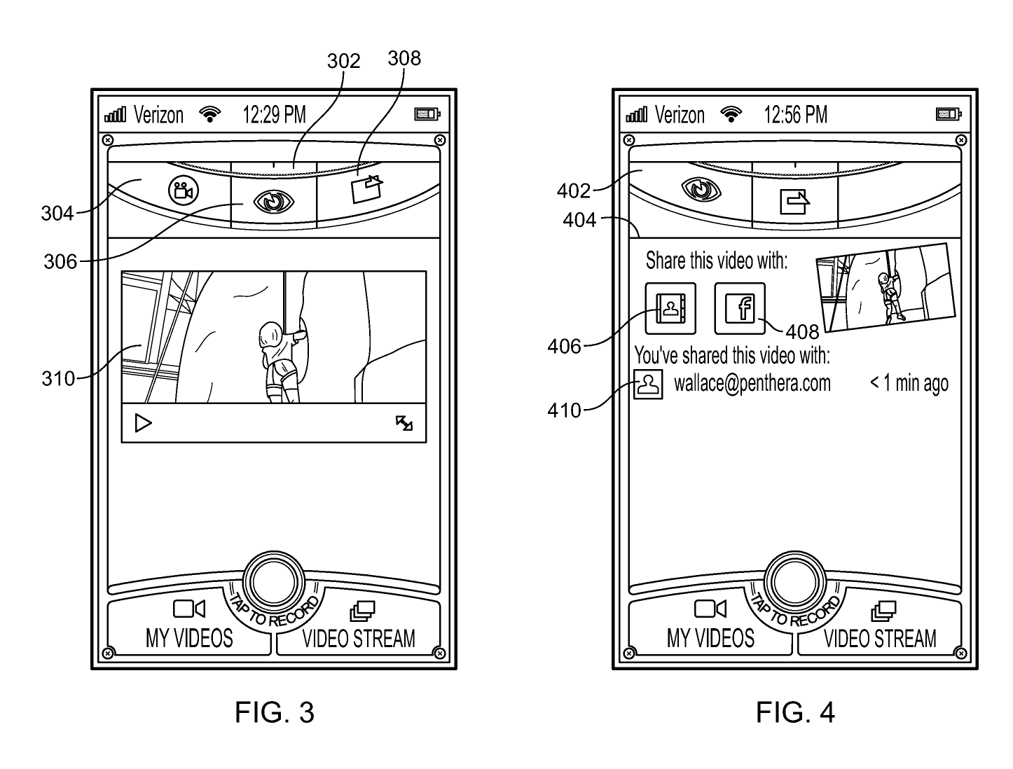

The user selects one or more of these videos. Having selected a video, the user selects an action from a menu (302 in FIG. 3). For example, 306 view the video or 304 upload the video to the Cloud Storage or 308 share the video with a friend. If the user elects to share the video, they may see a new screen (FIG. 4) with options to share the video with a contact (406) or post via a social networking service such as Facebook or Twitter 408. The user may also see a list of those people she has previously shared the video with 410.

For each video requiring upload from the device, the app will compress the video to a small fraction (say 1/16) of its original size, and queue the video for upload 114 to the Cloud Storage Server (CSS) 116. File upload may be using a variety of protocols, including FTP, HTTP, and proprietary protocols.

Once the upload of this video is complete, the app will then compress the original video somewhat less aggressively (say to ⅛ its original size) and queue that (higher-quality) video for upload. As shown in FIG. 5, the app repeats this process for progressively higher-quality versions 502, 504, 506, 508, 510 of the same video.

Once each version of the video is uploaded, the Control Plane may delete the previous (lower-quality) video on the CSS, or allow the multiple encodings to remain side-by-side. In either case, over time, the highest-quality version of the video stored on the CSS improves.

As soon as the first (lowest-quality) video has been uploaded, the video is then available for sharing with and viewing by friends and family. The Control Plane may (on the user's behalf) post the video to Facebook, send it to Twitter, and/or send an email or text containing a link to the video. Using one or more of these services, a recipient can then access the video on the CSS. The recipient can access the video from various endpoints: a browser-based PC/laptop, a smartphone/tablet, or a set-top box with appropriate software. Other implementations may also be possible for uploading, storing, and giving access to others.

The Control Plane may notify the recipient of the shared video in many ways. One way is to send an email (FIG. 6) to the recipient. The email may contain a button or link 604 to the video, which the recipient can click on to view the video, streamed from the CSS to the recipient. The email may also contain a link 606 for the recipient to download and install the application onto their own mobile device(s). (In this screen shot, Ribit is the brand name of the mobile application.)

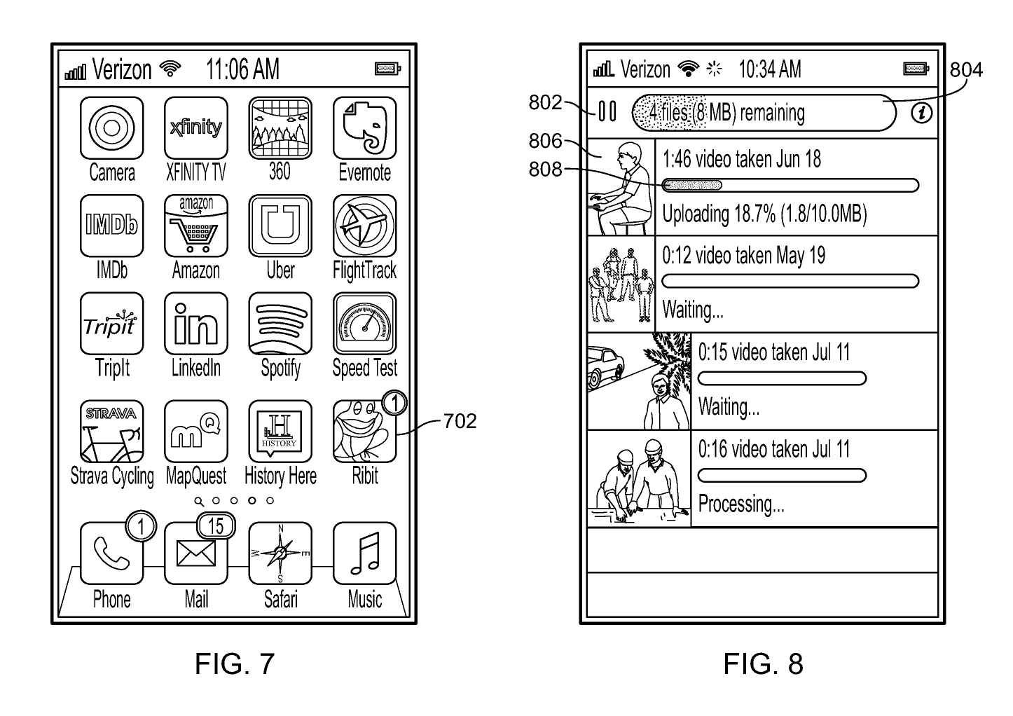

Another approach is to send a text message to the recipient's mobile phone. Another approach, if the recipient has the mobile application installed on their device, is to send a notification directly to the application itself - notifications can be implemented using such tools and protocols as Apple Push Notifications (APN), Android C2DM, and Urban Airship. There may also be other approaches for notifying the recipient of a newly-available video. FIG. 7 (702) shows the result of an APN signal sent to an iPhone device running this application.

We now walk through the complete sequence of steps from the capturing to the consumption of a personal video using the product described in this invention.
1. Stacy visits New York City. She launches the app on her smartphone. She shoots a video.
2. From within the app, Stacy selects a recipient (her grandmother) from her contacts list and shares the video with that contact
3. The app uploads the video from Stacy's phone to the CSS
4. The Control Plane sends an email to Stacy's grandmother. The email contains a link to the video file on the CSS.
5. Stacy's grandmother receives the email, clicks on the link, and watches the video on her tablet or laptop or desktop or other Internet-connected device.

If the recipient accesses the video right away, she will see the lowest-quality version of the video. If the recipient doesn't access the video until later, she may at that time see a higher-quality version of the video, because some higher-quality version(s) will have in the meantime been uploaded to the CSS. When the recipient begins playing a lower-quality video, she may (before the video starts playing) see a message: “you may watch the video now, but be aware that a higher-quality version is being uploaded . . . come back later to watch it again in higher quality!” This message may be superimposed on the video, or may precede or follow it.

Assuming the CSS has stored multiple versions of the uploaded video in various qualities, the CSS can detect the quality of the network link between it and the video consumer, and select for delivery the highest quality version of the video that can reliably be delivered over that link. The selection could be dynamic, adapting every 10 seconds based on network quality (one such technique is called HTTP Live Streaming or “HLS”).

### Upload Policy

The mobile app may elect to defer uploads of higher-quality (e.g., very large) encodings (version) until conditions are favorable. For example, one policy might be:
defer files larger than 20 MB until WiFi is available
defer files larger than 20 MB until battery charge is >75%

If a video upload is deferred, the app may notify the user that there are still video(s) pending upload. The app may also explain to the user how to resume the uploads. E.g., a message: “You have 3 remaining videos to upload. To upload the files, be sure you're in a WiFi hotspot and charging.”

### Upload Queue

The client app may present to the user (FIG. 8) an indication of how many videos and how many bytes are still pending upload. The display may provide “live” updates—e.g. with a moving progress bar 804 and a reported fraction complete 808.

The app may show a separate entry in the queue for each encoding of a video, e.g., 5 separate entries for a single video, each at different quality. Alternatively, the app may show a single entry in the queue for each video.

The app may allow the user to pause the uploads 802, or to reorder the uploads and to delete a pending upload.

### Interleaved Queue of Videos

If more than one video is queued for upload, the system may interleave the uploading order of the various encodings as follows:
Video1: 1/16 quality
Video2: 1/16 quality
Video1: ⅛ quality
Video2: ⅛ quality
Video1: ¼ quality
Video2: ¼ quality and so on.

More generally, if two video encodings are queued for upload, the one with the lower-quality encoding has a higher priority and is uploaded first.

This approach ensures that if the user takes multiple videos, a version of each video shows up quickly on the Cloud storage system.

If the user takes a new video (say Video 3), while some existing videos are already queued for upload, the lowest-quality encoding of Video 3 will be prioritized before the higher-quality encodings of Videos 1 and 2. This provides “immediate gratification” to the user, i.e., their newly-taken video is uploaded quickly to the CSS, while the higher-quality encodings of Video 1, 2, and 3 are still queued for upload.

### Video Compression

There are many ways to compress a video and this invention does not presume a specific implementation. Purely as examples (but not meant to be restrictive), compression may include reducing the frame rate (e.g. 30 fps down to 15 fps), reducing the pixel dimensions of the video (e.g. 1080 pixels wide down to 720 pixels), and reducing the encoding bitrate of the accompanying audio file (e.g. from 128 kbs to 64 kbs).

### Configuration

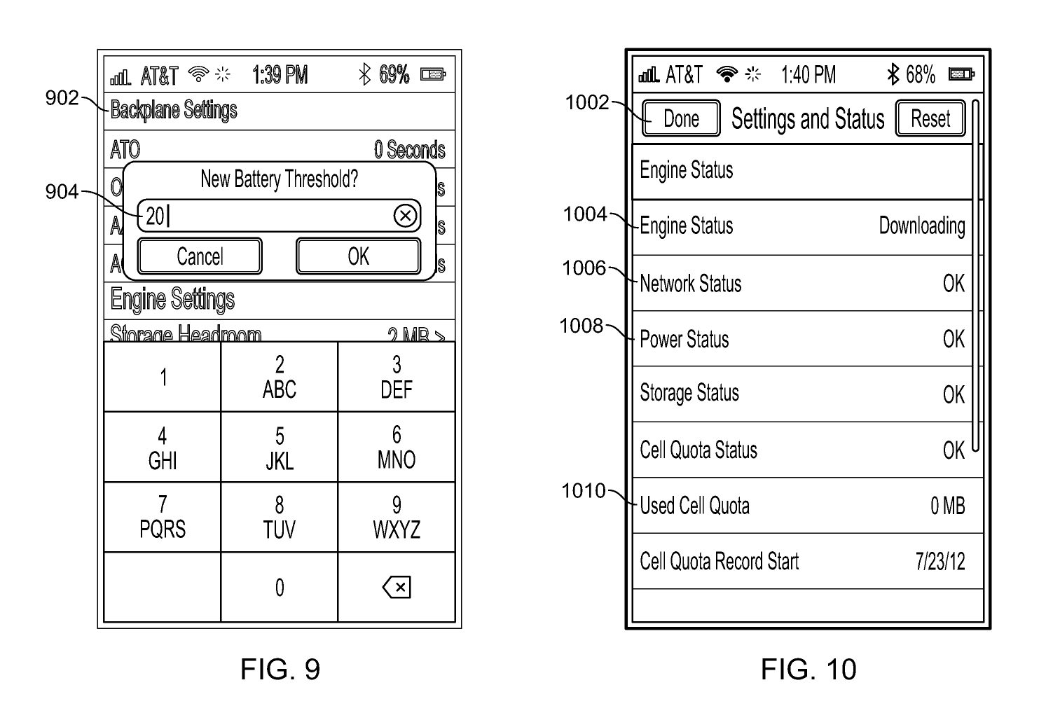

The system may allow (see FIG. 9) the user to configure the behavior of the app in how and when the app uploads videos. For example, the user can set a battery threshold 904, below which the application should not perform any video uploads.

More generally, the app may present to the user a diagnostic screen (FIG. 10) which shows the current status of the app and whether all the conditions are favorable to uploading. The app can monitor conditions such as the network status 1006 (e.g. upload over WiFi is permitted, but not over cellular), the power status 1008 (e.g. upload is only permitted when battery is more than 50% charged), the cell quota status 1010 (e.g. uploads are permitted over a cellular connection only until the app has uploaded 500 MB of data over cellular in the current week)

### Variations

A wide variety of other implementations are possible. For example:

The app can start at a different video encoding, e.g., 1/32 size or even lower-quality.

The app can terminate at a different video encoding, e.g., ½ the original size.

The steps do not need to be powers of two.

The user can configure the various compression levels of the videos.

The user can configure when to send the notification to the recipient (after the initial encoding has been uploaded, or after some higher-quality version has been uploaded, or both).

1. A computer-implemented method comprising
uploading from a mobile device to a server two or more versions of at least portions of a video that has been captured at the mobile device, each of the two or more versions requiring different amounts of communication resources, the order of uploading of the respective versions being determined based on a size of the version.

2. The method of claim 1 in which the two or more versions comprise two or more degrees of compression.

3. The method of claim 1 in which one of the versions has not been compressed and at least one of the versions has been compressed.

4. The method of claim 1 in which the order of uploading corresponds to relative degrees of compression of the two or more versions.

5. The method of claim 1 in which one or more of the versions are to be stored at the server for delivery to other devices.

6. The method of claim 1 in which the uploading comprises uploading a highly-compressed, low-quality version of the video first, and subsequently uploading one or more higher-quality larger versions of the video.

7. The method of claim 6 in which the uploading comprises uploading a higher-quality version of the video to replace a lower-quality version.

8. The method of claim 6 in which the uploading comprises uploading a higher-quality version of the video to be maintained in addition to a lower-quality version.

9. The method of claim 1 in which the versions of the video are uploaded from a mobile application running on the mobile device.

10. The method of claim 1 comprising displaying to a user of the mobile device information about videos that are queued for upload.

11. The method of claim 10 comprising enabling a user to control the uploading.

12. The method of claim 1 in which uploading is controlled based on uploading conditions.

13. The method of claim 12 in which uploading is deferred for files larger than a predetermined size until a local wireless connection having a relatively large bandwidth is available.

14. The method of claim 12 in which uploading is deferred for files larger than a predetermined size until a WiFi connection is available.

15. The method of claim 1 in which uploading is deferred for files larger than a predetermined size until a charge level of a battery of the device exceeds a predetermined threshold.

16. The method of claim 1 in which uploading is deferred for files larger than a predetermined size until a charge level of the battery of the device exceeds a predetermined threshold and a Wi-Fi connection is available.

17. The method of claim 1 comprising notifying a user of the device that the uploading is pending.

18. The method of claim 1 comprising indicating to a user of the mobile device a number of videos remaining to be uploaded or a number of bytes of files to be uploaded or both.

19. The method of claim 1 comprising indicating to a user of the mobile device a progress of uploading of each of two or more different versions of a single video.

20. The method of claim 1 comprising enabling a user of the mobile device to control an order in which the two or more versions are uploaded or to delete a pending upload or both.

21. The method of claim 1 in which the uploading comprises interleaving uploading of two or more versions of each of two or more videos so that lower-quality versions of two or more of the videos are uploaded before higher-quality versions of any of the videos are uploaded.

22. The method of claim 1 comprising enabling a user of the mobile device to control how or when the videos are uploaded.

23. The method of claim 22 comprising enabling the user to set a battery threshold below which uploading a video should be suspended.

24. The method of claim 23 comprising displaying to the user the state of conditions that relate to the favorability of uploading.

25. The method of claim 24 comprising monitoring the conditions.

26. The method of claim 25 in which the conditions comprise one or more of a power state or availability of a cellular connection to upload additional data within a subscription.

27. A computer-implemented method comprising
receiving and storing at a server at a location that is accessible from mobile devices through a public network, two or more successively uploaded versions of at least portions of videos that have been captured at the mobile devices, at least one of the later uploaded versions being of a higher-quality than one of the previously uploaded versions for a given one of the videos.

28. The method of claim 27 comprising
delivery of one or more of the versions of a given video to one or more devices other than the one at which the video was captured.

29. The method of claim 28 in which the delivery to the one or more other devices occurs almost immediately after the video has been captured.

30. The method of claim 27 in which lower quality versions of a given video are deleted from the server after higher-quality versions have been uploaded to the server.

31. The method of claim 28 in which the delivery comprises streaming.

32. The method of claim 28 in which the delivery comprises downloading of the file.

33. A computer-implemented method comprising
at a server that is accessible on a public from mobile devices and other devices, managing (a) uploading of two or more versions of respective videos that are captured on mobile devices, (b) storage of two or more of the versions, and (c) delivery of one or more of the versions of a given video to one or more of the mobile devices or other devices or other devices.

34. The method of claim 33 comprising sending notifications recipients of videos to indicate that the videos are available for viewing.

35. The method of claim 33 in which the managing comprises causing the deletion of one or more versions of a given one of the stored videos.

36. The method of claim 33 in which the managing comprises posting a given video on a social network site.

37. The method of claim 33 in which the managing comprises sending an e-mail or text message containing a link to a given one of the videos to an authorized recipient of the video.

38. The method of claim 33 in which the managing comprises responding to a request from one of the devices for access to one of the videos by arranging for the device to have access from the storage.

39. The method of claim 33 in which the managing comprises delivering a lower quality version of a given video until a higher-quality version is available in storage.

40. A mobile device comprising
an application to upload two or more versions of at least portions of a video that has been captured at the mobile device through a public communication network to a server for storage, the respective versions being uploaded in order determined based on a size of the version and an urgency of uploading.

41. The mobile device of claim 40 comprising a video capture device.

42. The mobile device of claim 40 in which the application is to form one or more of the versions by compressing a version of the video.

43. The mobile device of claim 40 in which the application is to enable a user to control the uploading.

44. The mobile device of claim 40 in which the application is to indicate to the user a status of the uploading.

45. The mobile device of claim 40 comprising a monitoring element to monitor conditions of the mobile device associated with it capability to upload.

46. The mobile device of claim 45 in which the conditions include a power state and a usage level of bandwidth of a communication subscription.
